(19) United States
(12) Patent Application Publication
(10) Pub. No.: US 2008/0109716 A1
(43) Pub. Date: May 8, 2008

(54) APPARATUS AND METHOD FOR EDITING AND DISPLAYING WEB DOCUMENT

(75) Inventor: Kyung-eun LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/747,294

(22) Filed: May 11, 2007

(30) Foreign Application Priority Data
Nov. 6, 2006 (KR) 10-2006-0108831

(51) Int. Cl. G06F 17/00

(52) U.S. Cl. 715/254; 715/255; 715/205

(57) ABSTRACT

A method and apparatus for editing and displaying a web document, and a browser are provided. The apparatus for editing and displaying a web document includes a browser which classifies the content of the web document received through the Internet into two or more classified parts; and a display which displays only a summary of the web document partially including the classified parts, wherein the browser additionally displays a portion of a non-displayed item selected from the summary of the web document displayed on the display. Accordingly, in consumer electronics employing a method of editing and displaying a web document, even if the consumer electronics do not include an input unit such as a mouse or a touch pen, it is possible to easily and rapidly browse a large amount of web documents by using only a direction key.

### CROSS-REFERENCE TO RELATED PATENT APPLICATION

This application claims priority from Korean Patent Application No. 10-2006-0108831, filed on Nov. 6, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to the editing and displaying of a web document by a client computer, and more particularly, to the editing and displaying of a web document, which allows a user to easily browse the web document in consumer electronic devices having only a small number of input keys, such as a four-direction key.

2. Description of the Related Art

FIG. 1 illustrates a web document displayed on a screen of a general computer monitor as a result of searching the Internet. A user connects his or her computer (client computer) to a server computer for an Internet search engine and requests the server computer to search the Internet by using the keyword “Korea”. The sever computer performs a search operation. A search result is written in a web document with a specific format and sent to the client computer. The client computer then displays the web document on its monitor 11 in compliance with the specific format used in the server computer. In this case, the Microsoft Internet Explorer is used in the client computer as a browser. As shown in FIG. 1, the Internet Explorer is currently widely used as a browser and displays a web document on the monitor 11 in the same format as written in the server computer.

However, if the web document is desired to be displayed on a screen of a portable device such as a personal digital assistant (PDA) or a portable multimedia player (PMP) in the same manner as described above, only a portion of the web document is displayed. This is because, for portable use, a display 12 of the portable device generally has a significantly smaller size than a display 11 of a computer. For example, as shown in FIG. 1, the display 11 of a general computer can display more than seven (4 to 10) items. On the other hand, the display 12 of the portable device has a smaller size, and thus only about three (4 to 6) items can be displayed. When the portable device is used, in order to browse items (7 to 10) not displayed on the display 12, the user has to scroll and move the web document.

Generally, for an input unit, as shown in FIG. 2, the portable device does not include a mouse or a keypad but includes only a small number of keys (or buttons) such as a four-direction key 21. Thus, it is inconvenient for the user to move the web document. Additionally, in order to select one of the items (4 to 6) displayed on the display 12, the four-direction key 21 has to be used to move a focus. Unlike the mouse, when the four-direction key 21 is used, the focus moves across all items. Thus, a relatively long time and many key operations are required to select items. Furthermore, since the user does not always have an interest in all of the displayed items, there is no need to display detailed descriptions for the respective items.

In order to enable web surfing, an Internet protocol television (IPTV) set or a Japanese TV set includes a browser that can support a web document written in the HTML format. Since a display such as the Japanese TV set has a size larger than a computer monitor, a large amount of information can be concurrently displayed on the display. However, since a remote control which is used as an input unit for the Japanese TV set is constructed with a plurality of keys similar to that of the portable device, the same problems which occur in the portable device are also produced in the Japanese TV set. For example, when a web document is too long to be entirely displayed on a TV screen, the web document has to be scrolled to move in order to view a non-displayed portion of the web document.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for editing and displaying a web document which allow a user to easily browse the web document, and a browser for allowing display of the web document.

According to an aspect of the present invention, there is provided an apparatus for editing and displaying a web document, comprising a browser which classifies the content of the web document for each item received through the Internet into two or more parts according to classes, and a display which displays only a summary of the web document partially including the classified parts for each item, wherein the browser additionally displays the non-displayed classified parts of the item selected from the summary of the web document displayed on the display.

According to another aspect of the present invention, there is provided a method of editing a web document, comprising receiving the web document through the Internet; classifying the content of the web document into two or more parts according to classes; and making a mapping table containing information regarding a relationship between the classified parts of the web document.

According to another aspect of the present invention, there is provided a method of displaying a web document, comprising displaying a summary of the web document partially including classified parts for each item; selecting a desired item from the summary of the web document by a user; searching for non-displayed parts corresponding to displayed parts of the selected item by using a mapping table; and additionally displaying the searched non-displayed parts.

According to another aspect of the present invention, there is provided a browser for editing and displaying a web document, comprising an element which classifies the content of the web document received through the Internet into two or more parts according to classes; an element which partially displays the classified parts of the content of the web document; and an element which additionally displays non-displayed parts of the content of the web document.

### BRIEF DESCRIPTION OF THE DRAWINGS

The above and other aspects of the present invention will become more apparent by describing in detail exemplary embodiments thereof with reference to the attached drawings in which:

FIG. 1 illustrates a web document displayed on a computer monitor according to a related art method;

FIG. 2 illustrates an example of a portable device that can display a web document according to an exemplary embodiment of the present invention;

FIG. 3 is a block diagram of an apparatus for editing and displaying a web document according to an exemplary embodiment of the present invention;

FIG. 4 is a flowchart of a method of editing a web document according to an exemplary embodiment of the present invention;

FIG. 5 is a flowchart of a method of displaying a web document according to an exemplary embodiment of the present invention;

FIG. 6 illustrates a summary of a web document displayed according to an exemplary embodiment of the present invention; and

FIG. 7 illustrates a web document of which a description part is displayed according to an exemplary embodiment of the present invention.

### DETAILED DESCRIPTION OF THE INVENTION

Hereinafter, exemplary embodiments of the present invention will be described in detail with reference to the accompanying drawings.

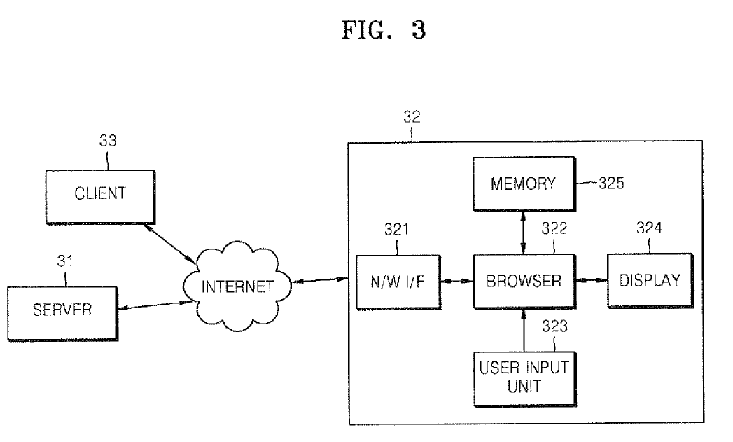

FIG. 3 is a block diagram of an apparatus for editing and displaying a web document according to an exemplary embodiment of the present invention.

An apparatus 32 for editing and displaying a web document includes a network interface 321, a browser 322, a user input unit 323, a display 324, and a memory 325. The apparatus 32 may be included in a portable multimedia player (PMP), a personal digital assistant (PDA), an Internet protocol television (IPTV) set, or a Japanese TV set. The apparatus 32 is electrically connected to a sever computer 31 or a client computer 33 through the Internet by wire or wirelessly, and receives the web document from the connected computer 31 or 33. Therefore, the apparatus 32 and the computer 31 or 33 support a transmission control protocol/internet protocol (TCP/IP) so as to support an Internet service. Furthermore, for communication purposes, the apparatus 32 and the computer 31 or 33 have to include an input/output port, a local area network (LAN) cable, and a modem.

The server computer 31 provides a search service and other various contents. In particular, the server computer 31 has to provide content to the client computer 33 in a web document format. A web document is an electronic file written in a program language (e.g., HTML, XHTML, and XML) for an Internet service.

To simplify the description, it will be assumed that the browser 322 does not only include an application program for editing and displaying a web document, but includes the application program along with hardware elements (e.g., a processor, a cache memory, etc) for executing the application program.

The display 324 outputs the web document so that the user can visually recognize the web document. The display 324 may be a liquid crystal display (LCD), but is not limited thereto.

The user input unit 323 receives a user command to operate the browser 322. The user input unit 323 includes a small number of keys such as a four-direction key 21, an enter key, etc.

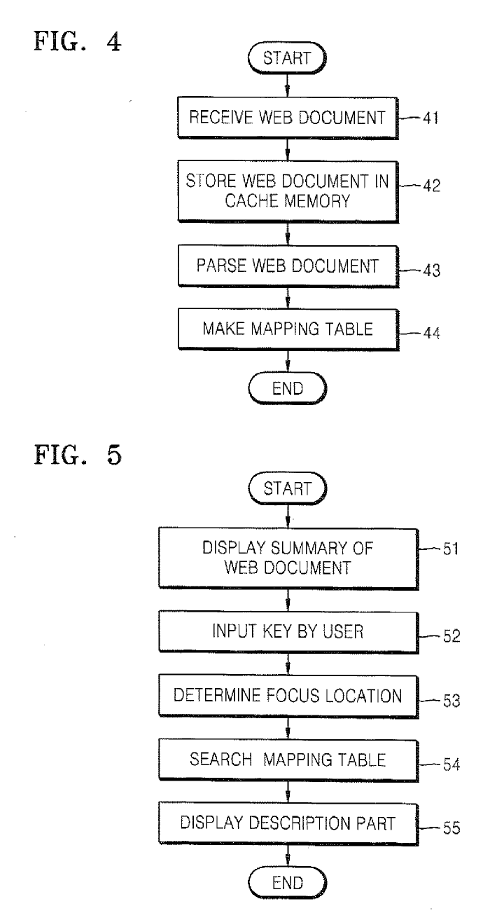

FIG. 4 is a flowchart of a method of editing a web document according to an exemplary embodiment of the present invention.

In operation 41, the web document is received. The apparatus 32 is connected to the server computer 31 or the client computer 33 by wire or wirelessly and receives the web document from the connected computer 31 or 33.

In operation 42, data of the web document received in operation 41 is stored in a cache memory.

In operation 43, the web document is parsed. Each item of the received web document is composed of a title part and a description part. The browser 322 parses the received web document and classifies the content of the web document into title parts and description parts. An example of parsing by the browser 322 will now be described.

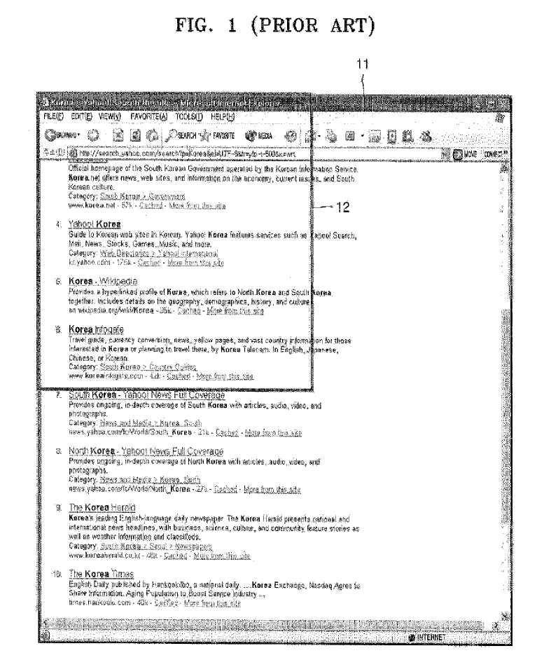

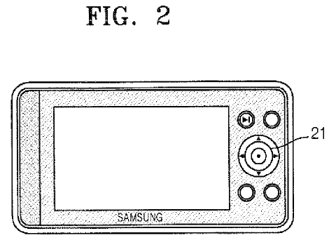

The followings are source codes corresponding to a ninth item (The Korea Herald) and a tenth item (The Korea Times) obtained from a search result shown in the web document of FIG. 1.

A title part and a description part are distinguished by a tag of <div></div>. For example, the title part of the ninth item (the Korea Herald) is identified by a first tag of <div></div>, and the description part thereof is identified by a second tag of <div></div>. Therefore, the content of the web document can be classified into the title part and the description part for each item by using the tag.

```
=============== Title Part Of The Korea Herald ===============
<li>
<div>
<a class=“yschttl ytrk31”]
href=“http://rds.yahoo.com/_ylt=A0geus50tz1FNGUAQ4pXNyoA;_ylu=X3o
DMTE4cGRiMTEzBGNvbG8DZQRsA1dTMQRwb3MDOQRzZWMDc3IEd
nRpZANZUzEwN18xMDM-/SIG=11h40d41v/EXP=1161758964/**
http%3a//www.koreaherald.co.kr/”> The <b>Korea</b> Herald</a>
</div>
============== Description Part Of The Korea Herald ==============
<div  class=yschabstr><b>Korea</b>'s  leading  English-language  daily
newspaper. The <b>Korea</b> Herald presents national and international
news headlines, with business, science, culture, and community feature stories
as well as weather information and classifieds.</div><div>  Category:  <a
class=ytrk32  href=“http://rds.yahoo.com/_ylt=A0geus50tz1FNGUARIp
XNyoA/SIG=135psd4el/EXP=1161758964/**http%3a//dir.yahoo.com/Regional
/Countries/Korea_{——}South/Cities/Seoul/News_and_Media/”>South
<b>Korea</b> &gt; Seoul &gt; Newspapers</a>
</div>
<em class=yschurl>www.<b>korea</b>herald.co.kr</em>
- <em>48k</em>
- <a class=ytrk33
href=“http://rds.yahoo.com/_ylt=A0geus50tz1FNGUARopXNyoA;_ylu=X3o
DMTEydjR0NWwyBGNvbG8DZQRwb3MDOQRzZWMDc3IEdnRpZANZ
UzEwN18xMDM-/SIG=15fj9127i/EXP=1161758964/**http%3a//
216.109.125.130/search/cache%3fp=korea%26fr=yfp-t-501%26toggle
=1%26ei=UTF-8%26u =www.koreaherald.co.kr/%26w  =korea%26d=
QIVR1SQ8Nqfd%26icp=1%26.intl=us”>Cached</a>
  - <a class=ytrk34
href=“http://rds.yahoo.com/_ylt=A0geus50tz1FNGUAR4pXNyoA/SIG=144t8
n5so/EXP=1161758964/**http%3a//search.yahoo.com/search%3fp=korea%26
toggle=1%26ei=UTF-8%26fr=yfp-t-501%26vst=0%26vs=
www.koreaherald.co.kr”>More from this site</a>
================ Title Part Of The Korea TIMES ================
<li>
<div><a class=“yschttl ytrk35”
href=“http://rds.yahoo.com/_ylt=A0geus50tz1FNGUASIpXNyoA;_ylu=X3oD
MTE5NDlyNzZuBGNvbG8DZQRsA1dTMQRwb3MDMTAEc2VjA3NyBH
Z0aWQDWVMxMDdfMTAz/SIG=11e09u5po/EXP=1161758964/**http%3a
//times.hankooki.com/”>The <b>Korea</b> Times</a>
</div>
============== Description Part Of The Korea Times ==============
<div class=yschabstr>English Daily published by Hankookilbo, a national
daily.  ...  <b>Korea</b>  Drama  Fest  Opens  in  Chinju  ...  Bank  of
<b>Korea</b> (BOK) Governor Lee Seong-tae said the country ...
</div>
<em class=yschurl>times.hankooki.com</em>
- <em>42k</em>
  - <a class=ytrk36
href=“http://rds.yahoo.com/_ylt=A0geus50tz1FNGUASopXNyoA;_ylu=X3o
DMTEzc2FxYWpzBGNvbG8DZQRwb3MDMTAEc2VjA3NyBHZ0aWQD
WVMxMDdfMTAz/SIG=15crue6rg/EXP=1161758964/**http%3a//216.109.1
25.130/search/cache%3fp=korea%26fr=yfp-t-501%26toggle=1%26ei=UTF-
8%26u=times.hankooki.com/%26w=korea%26d=ab-ykCQ8Nqlz%26icp=
1%26.intl=us”>Cached</a>
  - <a class=ytrk37
href=“http://rds.yahoo.com/_ylt=A0geus50tz1FNGUAS4pXNyoA/SIG=141t1
39o1/EXP=1161758964/**http%3a//search.yahoo.com/search%3fp=korea%2
6toggle=1%26ei=UTF-8%26fr=yfp-t-501%26vst=0%26vs=times.hankooki.
com” >More from this site</a>
```

In operation 44, a mapping table is made. The mapping table includes information regarding a relationship between the title part and the description part classified in operation 43 for each item. After the mapping table is completely made, the mapping table is stored in the memory 325.

FIG. 5 is a flowchart of a method of displaying a web document according to an exemplary embodiment of the present invention.

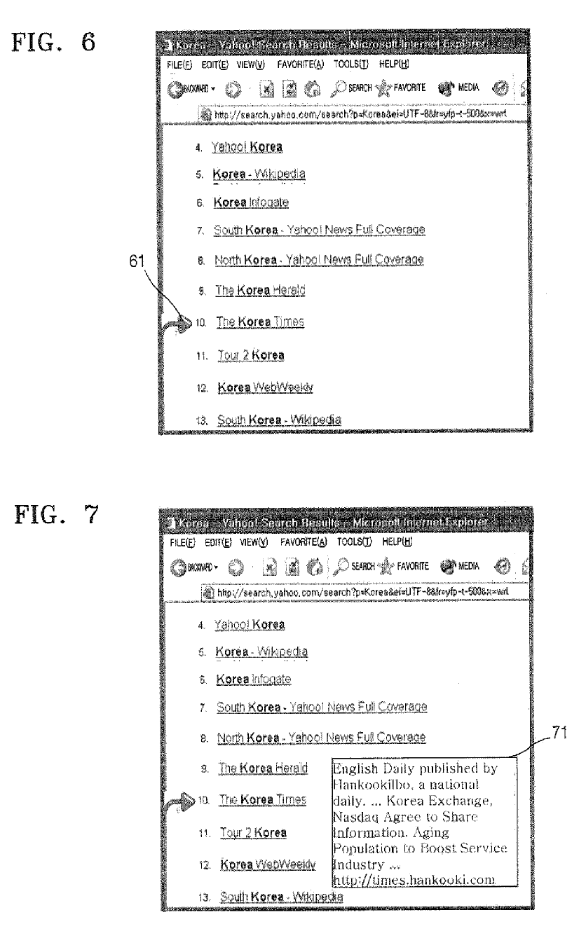

In operation 51, a summary of a web document is displayed. The browser 322 displays on the display 324 only a title part classified in operation 43 from the content of the web document stored in the cache memory. Hereinafter, the web document composed of only title parts will be referred to as a summary of a web document (FIG. 6).

In operation 52, the user inputs a key. The user uses the four direction key 21 or the like to move a focus 61 (FIG. 6) towards an interesting title in the summary of the web document on the display 324, and selects the interesting item.

In operation 53, a location of the focus 61 is determined. A title part indicated by the focus 61 on the display 324 is determined by the browser 322.

In operation 54, in order to find a description part corresponding to the title part indicated by the focus 61, the description part corresponding to the title part is searched for by using the mapping table.

In operation 55, the description part found in operation 54 is displayed on the display 324. Preferably, the description part pops up on the display 324 in the form of a message box. Furthermore, the description part is preferably displayed in an empty space on the display 324 so as not to overlap the title part. The message box disappears when the focus 61 moves. The message box may have various shapes and may be semi-transparently displayed.

FIGS. 6 and 7 illustrate web documents displayed by using a method of displaying a web document according to an exemplary embodiment of the present invention.

FIG. 6 illustrates an edited summary of a web document displayed on the display 324, wherein the web document of FIG. 1 is edited so that only title parts thereof are included. The user moves the focus 61 by using the user input unit 323 so as to locate the focus 61 at a tenth title part (The Korea Times). In the present exemplary embodiment of FIG. 6, an arrow is used as a focus style. However, in another exemplary embodiment, the focus style may have a shape different from the arrow. For example, an icon having a shape different from the arrow may be used as the focus style. Furthermore, instead of using the icon, a specific title part may be highlighted so as to be distinguished from other title parts. Thereafter, the browser 322 searches for a description part corresponding to the tenth title part by using the mapping table. Then, as shown in FIG. 7, the found description part is inserted in a message box 71 and is displayed in an empty space on the display 324. In FIG. 7, although the description part corresponding to the tenth title part is displayed in an empty space on the display 324, the exemplary embodiment of the present invention is not limited thereto, and thus the description part may be displayed to overlap the title part. In this case, the found description part may be displayed while being inserted in the message box 71. In this case, a background color for the found description part may be transparent. Alternatively, the background color may not be transparent in order to enhance user legibleness.

According to the exemplary embodiment of the present invention, in consumer electronics employing a method of editing and displaying a web document, even if the consumer electronics do not include an input unit such as a mouse or a touch pen, it is possible to easily and rapidly browse a large amount of web documents by using only a direction key.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An apparatus for editing and displaying a web document, the apparatus comprising:
a browser which classifies a content of the web document for an item of a plurality of items received through the Internet into two or more classified parts; and
a display which displays a summary of the web document partially including the classified parts for each item of the plurality of items,
wherein the browser additionally displays a non-displayed classified part of the item selected from the summary of the web document displayed on the display.

2. The apparatus of claim 1, further comprising a memory which stores a mapping table which contains information regarding relationship between the classified parts for each item of the web document.

3. The apparatus of claim 1, further comprising a user input unit by which a user selects one of the items of the plurality of items included in the summary of the web document.

4. The apparatus of claim 1, wherein the summary of the web document includes only title parts of the content of the web document received through the Internet.

5. The apparatus of claim 3, wherein the user input unit includes a plurality of direction keys.

6. The apparatus of claim 1, wherein the web document is received from a computer through the Internet.

7. The apparatus of claim 6, wherein the computer is a server for a search engine.

8. A consumer electronics device having an apparatus for editing and displaying a web document, the consumer electronics device comprising:
a browser which classifies a content of the web document for an item of a plurality of items received through the Internet into two or more classified parts; and
a display which displays a summary of the web document partially including the classified parts for each item of the plurality of items,
wherein the browser additionally displays a non-displayed classified part of the item selected from the summary of the web document displayed on the display.

9. A method of editing a web document, the method comprising:
receiving the web document through the Internet;
classifying a content of the web document into two or more classified parts; and
making a mapping table containing information regarding a relationship between the classified parts of the web document.

10. The method of claim 9, wherein the web document includes an Internet search result.

11. The apparatus of claim 9, wherein the two or more classified parts include a title part and a description part.

12. A method of displaying a web document, the method comprising:
displaying a summary of the web document partially including classified parts for items of the web document;
selecting a desired item from the summary of the web document by a user;
searching for non-displayed parts corresponding to displayed parts of the selected item by using a mapping table; and
displaying the searched non-displayed parts.

13. The method of claim 12, wherein the summary of the web document includes title parts of the content of the web document received through the Internet.

14. The method of claim 12, wherein the selecting of a desired item further comprises:
moving a focus to an item to select the desired item in the summary of the web document by using a plurality of direction keys; and
determining a location of the focus to find the selected item.

15. The method of claim 12, wherein, in the displaying of the non-displayed parts, the non-displayed parts are displayed to overlap the summary of the web document.

16. The method of claim 12, wherein, in the displaying of the non-displayed parts, the non-displayed parts are displayed in an empty space of the web document.

17. The method of claim 15, wherein the non-displayed parts are inserted in a message box and are displayed in a pop-up manner.

18. A browser for editing and displaying a web document, the browser comprising:
an element which receives content of the web document through the Internet;
an element which classifies the content of the web document received through the Internet into two or more classified parts;
an element which partially displays the two or more classified parts of the content of the web document; and
an element which displays non-displayed parts of the content of the web document.

19. The browser of claim 18, further comprising an element which stores a mapping table containing information regarding a relationship between the classified parts of the web document.

20. The browser of claim 19, further comprising an element which searches for the non-displayed parts corresponding to the displayed parts by using the mapping table.

21. The browser of claim 18, wherein in the element which classifies, the content of the web document is classified by using tags of a source code of the web document.

22. A portable device having a browser for editing and displaying a web document, the browser comprising:
an element which receives content of the web document through the Internet;
an element which classifies the content of the web document received through the Internet into two or more classified parts;
an element which partially displays the two or more classified parts of the content of the web document; and
an element which displays non-displayed parts of the content of the web document.

23. The portable device of claim 22, further comprising a plurality of direction keys.

24. A computer-readable medium having embodied thereon a computer program for executing a method of editing and displaying a web document, the program comprising:
receiving the web document through the Internet;
classifying a content of the web document received through the Internet into two or more classified parts;
partially displaying the classified parts of the content of the web document; and
displaying non-displayed parts of the content of the web document.

25. The computer-readable medium of claim 24, wherein the program further comprises storing a mapping table containing information regarding a relationship between the classified parts of the web document.

26. The computer-readable medium of claim 25, wherein the program further comprises searching for non-displayed parts corresponding to the displayed parts by using a mapping table.
